(19) United States
(12) Patent Application Publication
(10) Pub. No.: US 2015/0211287 A1
(43) Pub. Date: Jul. 30, 2015

(54) ANTI-BURGLARY SLIDING FRAMES SYSTEM

(71) Applicant: Grigorios ZAFEIROPOULOS, Ano Liossia Attikis (GR)

(72) Inventor: Grigorios Zafeiropoulos, Ano Liossia Attikis (GR)

(21) Appl. No.: 14/420,388

(22) PCT Filed: Aug. 8, 2013
(86) PCT No.: PCT/GR2013/000042

§ 371 Date: Feb. 9, 2015

(30) Foreign Application Priority Data
Aug. 9, 2012 (GR) 20120100417

(51) Int. Cl. E06B 5/11; E05C 19/00; E05B 65/08

(52) U.S. Cl. CPC E06B 5/113; E05B 65/08; E05C 19/00

(57) ABSTRACT

By this invention it is possible to construct a sliding frame's system—glazing and shutter—, which has a frame guide profile (1) with a groove (2)—see FIG. 1—and a sash profile (3), on which the locking profile (4) is placed into the groove (5)—see FIG. 2—. The locking profile (4) has a helical groove (11)—see FIG. 7—, where the pin (10) of the sliding framework's cremone enters. Two clamping parts (6)—see FIG. 6—are placed within the chamber (5) of the sash (3) at the two edges of the locking profile (4). Each clamping part (6) has a groove (7) as a motion driver of the locking profile (4). As the cremone rotates, it transforms the rotary motion into linear made by the cremone's pin (10), which forces the locking profile (4) to rotate and entrap the movable frame of the sash's profile (3) into the groove (2) of the stable frame guide profile (1) along the full height of a sliding door or window.

This invention refers to an anti-burglary sliding frames system, applicable to doors and windows, glazing and shutters, whose two main profiles—the frame guide and the sash—are designed in such a way that allows the entrapment and the full lock of the sash's movable sliding framework, into the stable frame of the frame guide attached to the wall, by adding the minimum number of accessories.

Up to this day, when it comes to aluminium systems for sliding doors and windows, the manufacturing technology has not shown any similar invention. Contrariwise, current system manufacturers have been using a number of expensive accessories and complicated methods in their attempt to achieve the sliding framework's locking into the sash's profile; and, finally, these methods produce various locking points throughout the system, however insufficient, as they fail to achieve the totally secure locking between the two frames, meaning the system is still not burglar-proof; it is vulnerable even to rather simple forms of mechanical pressure exerted upon the frame's locking mechanism. Also, at the stage of sliding aluminium frame installation in a building, the adjustment of the striker plates with the locking sub-mechanisms of the sliding frames systems is a difficult process, that requires very specific measurements that can be time consuming.

This invention aims to surpass the disadvantages described above, by following a new and groundbreaking design and construction method of the sash's and the frame guide's profiles used in sliding systems for doors and windows. When the cremone is rotated into locking position, the sliding frame's sash gets embodied along its entire height with the door's or window's profile of the frame guide; this way, we achieve totally secure locking along the whole height of the sliding frame's profile, not only at various locking points, and, as a result, the system becomes absolutely burglarproof.

An example of the system's construction method is described hereunder, along with references to drawings, which clearly illustrate the way in which the invention's basic principle is implemented, while:

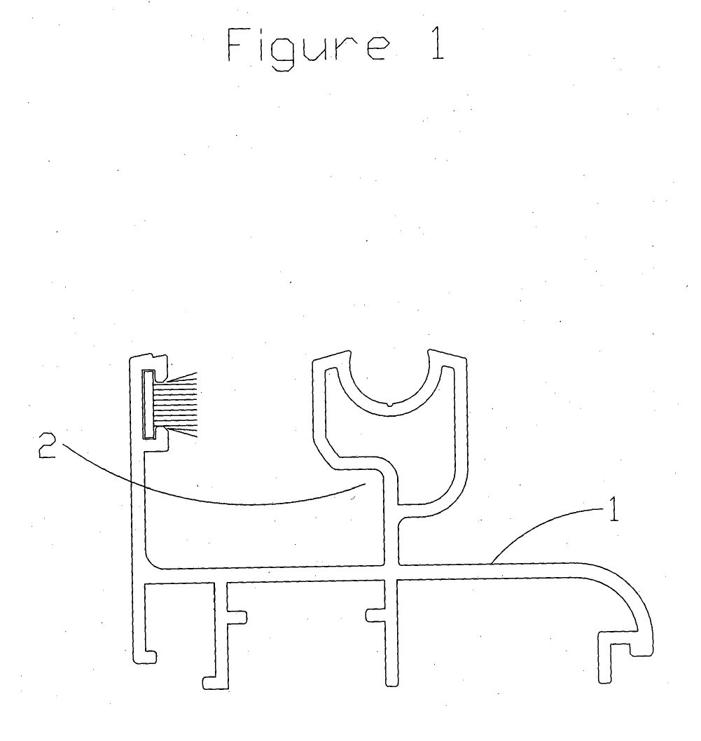

FIG. 1 illustrates the cross section of a common aluminium frame guide profile (1), which has been designed having as its main characteristic the existence of a groove (2).

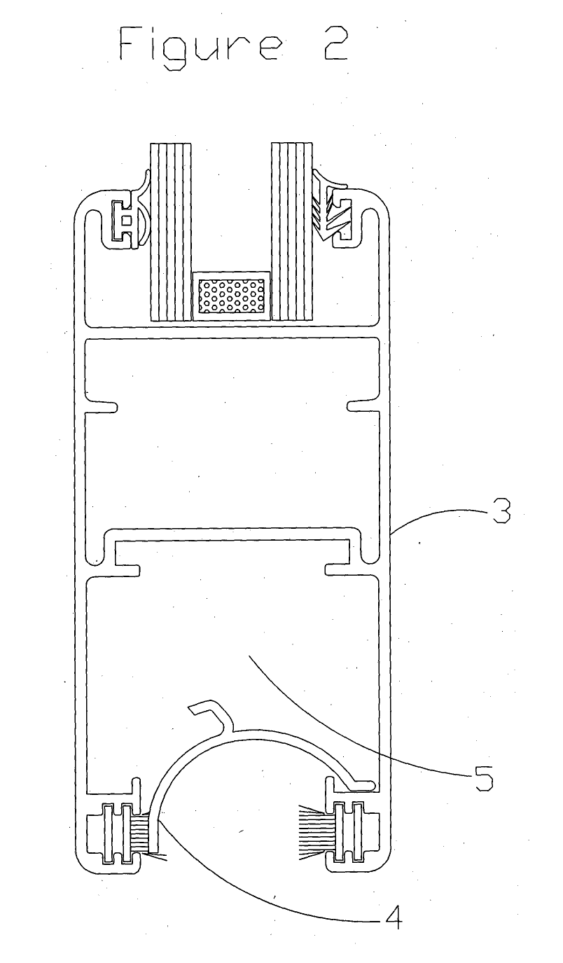

FIG. 2 illustrates the cross section of an aluminium sash profile (3) with a groove (5), where the locking profile (4) is placed.

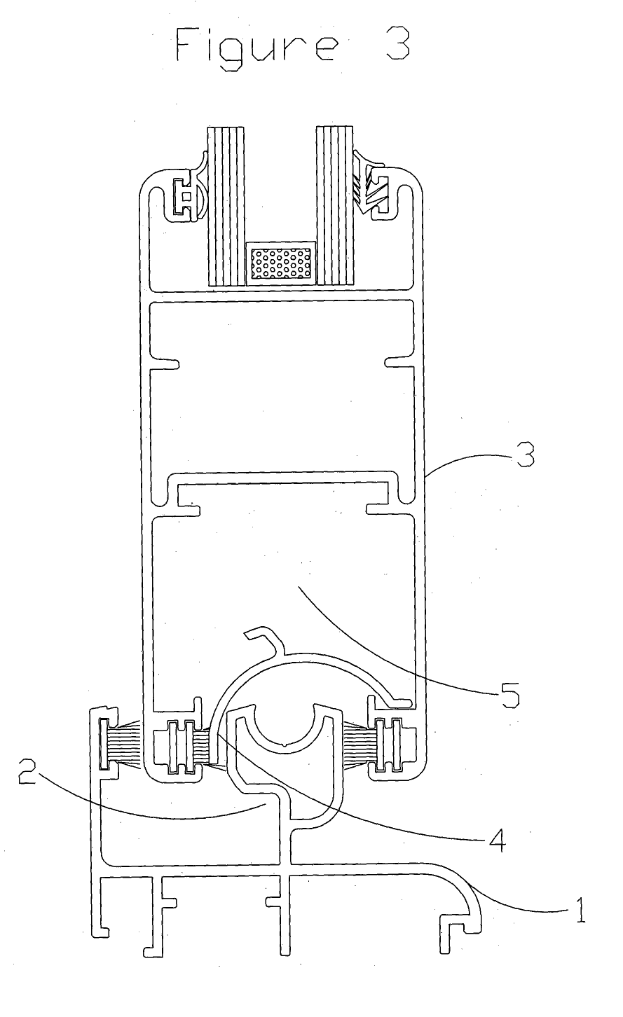

FIG. 3 illustrates the cross section of the locking profile (4) being placed into the groove (5) of the aluminium sliding sash's profile (3), in its final positioning in relation to the profile of the frame guide (1). In FIG. 3, the locking system has not been yet activated.

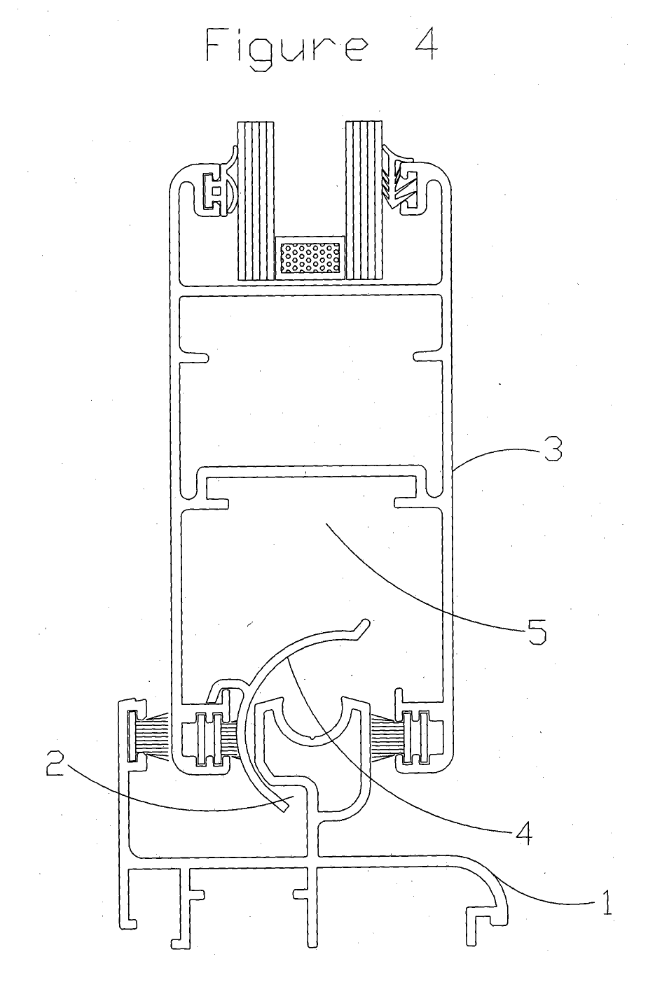

FIG. 4 illustrates the same cross section as FIG. 3 does, with the difference that the locking system is activated and the locking profile (4) is rotated and entered into the groove (2) of the aluminium frame guide's profile (1); as a result, the sliding sash's profile (3) gets embodied with the aluminium frame guide's profile (1) and the whole sliding frame is eventually locked along the whole height of the door or the window.

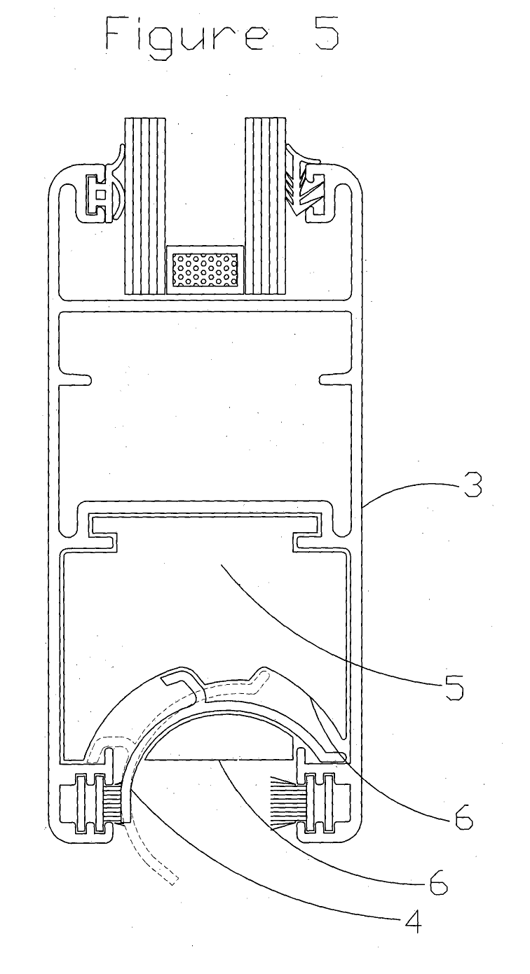

FIG. 5 illustrates a cross section of the accessory (6) which is placed into the groove (5) of the profile of the sliding sash (3).

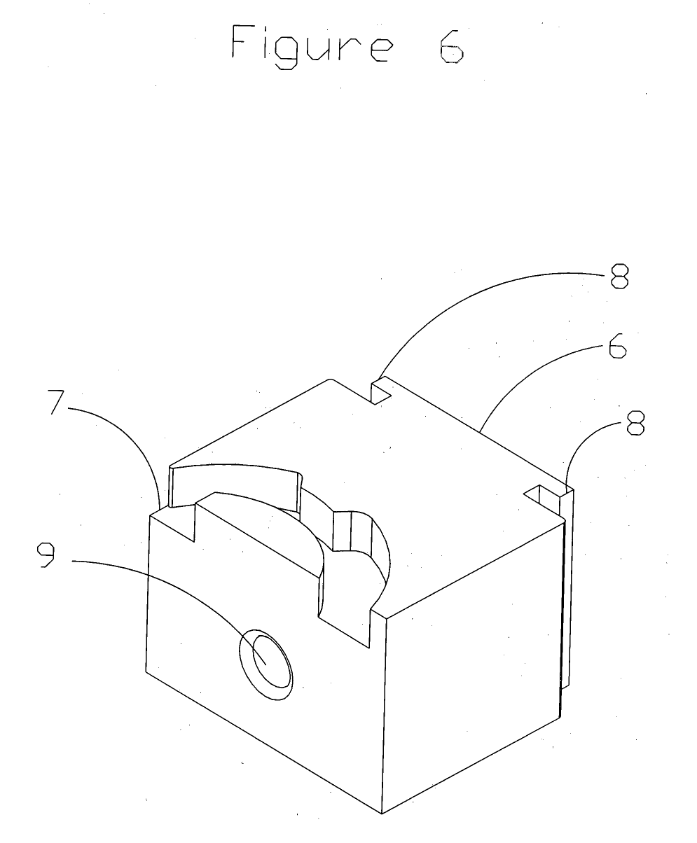

FIG. 6 is a 3-D illustration of the clamping part (6) which has a groove (7), which groove is also the motion driver of the locking accessory (4). The clamping part (6) has two lateral projections (8) which help and guide its entering into the sliding sash's profile groove (5) of the sliding sash's profile (3). Additionally, the clamping part (6) has a throughbore (9), in which a common screw goes, in order to stabilize the clamping part (6) on the sliding sash's profile (3) at the desired upper and lower positions.

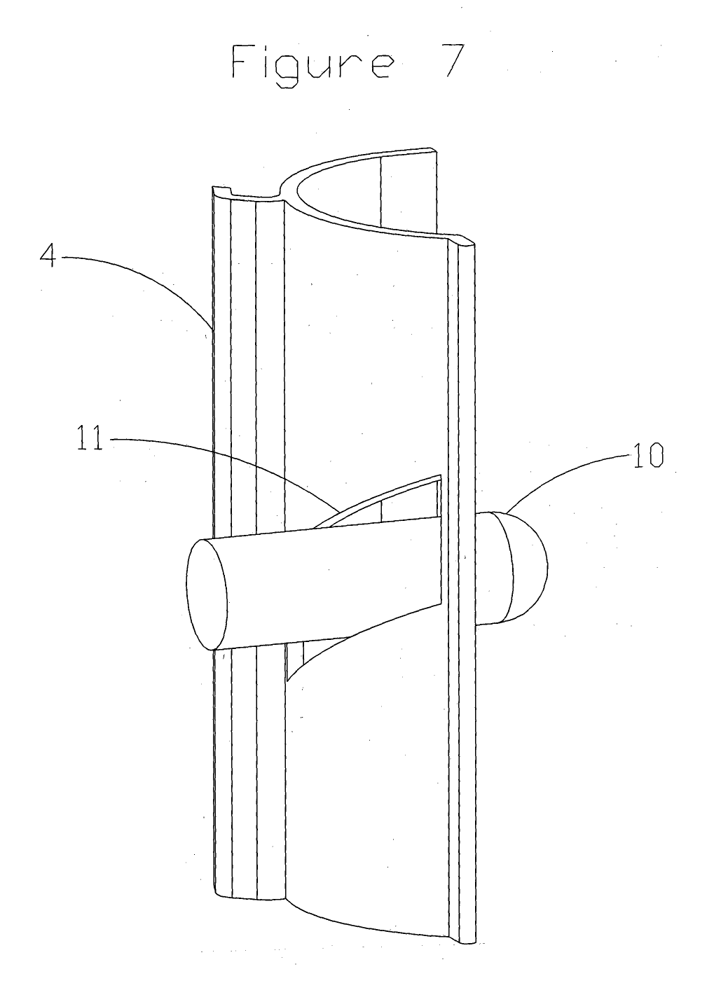

FIG. 7 illustrates the way in which the pin (10) of the cremone—commercially available—goes into the helical groove (11), which has been created on the locking profile (4) half way along its height.

The conversion of the pin's (10) linear motion into a rotational motion of the locking profile (4) is obtained as follows: When the cremone is rotated, it moves the pin (10) in a linear manner, and as it is moving into the helical groove (11), it forces the locking profile (4) to rotate and trap the sash (3) into the groove (2) of the frame guide (1).

Using the sash's profile (3), the movable sliding frame for doors and windows can be assembled and installed on the stable framework, which uses the frame guide's profile (1), according to the customs of common technology.

The basic implementation principle of the locking method according to this invention, can be applied in the three basic phases that follow:

Phase 1: The locking profile (4) is placed into the groove (5) of the sliding sash's profile (3) along its whole, height. The locking profile (4) has the helical groove (11) half way along its height in which the cremone's pin (10) enters.

Phase 2: Two clamping parts (6) are placed within the chamber (5) of the sash (3) at the two upper and lower edges of the locking profile (4).

Phase 3: As the cremone rotates, it transforms the rotary motion to linear motion of the cremone's pin (10), which in its turn forces the locking profile (4) to rotate and entrap the sash (3) into the groove (2) of the frame guide (1). At this phase, the movable sliding frame, which is made of the sash profile (3)—glazing or shutter—, is locked and embodied with the stable framework, which is made of the frame guide profile (1), in such a way that it makes the whole sliding aluminium framework completely burglar-proof.

As the cremone returns to its original position, the mechanism described above is activated backwards and it unlocks the movable sliding frame of the sash's profile (3), from the stable framework of the frame guide profile (1), since the locking profile (4) is also forced to return to its original position in the groove (5) of the sash (3), along the whole height of the sliding door or window.

The extremely strong and absolutely secure embodiment of the two frames—movable and stable frame—of the aluminium sliding framework for doors or windows, as it was described in the above, constitutes the main principle of the invention.

The previously described main accessories and materials can be used in any desired form and any size or shape, and they function according to their main purpose, as it is shown in the drawings attached to this document.

When it comes to different needs concerning the construction process, the forms of the accessories could be transformed, whilst retaining the main principle of the invention, as well as its advantages, which are the result of studying and designing this invention.

1: An anti-burglary sliding frames system, for doors and windows, characterized by the fact that it owns an aluminium frame guide profile (1) with a groove (2), as well as a sash profile (3) with a groove (5), inside of which the locking profile (4) is placed. The locking profile (4) has a helical groove (11) half way along its height, in which the pin (10) of the sliding framework's cremone enters. Two clamping parts (6) are placed within the chamber (5) of the sash (3) at the two upper and lower edges of the locking profile (4). Each clamping part (6) has a groove (7), which enables it to be the motion driver of the locking profile (4), at the same time.
